(19) United States
(12) Patent Application Publication
(10) Pub. No.: US 2024/0296350 A1
(43) Pub. Date: Sep. 5, 2024

(54) COMPUTED VALUES FOR KNOWLEDGE GRAPH

(71) Applicant: Yext, Inc., New York, NY (US)

(72) Inventors: Jesse SHATSKY, Brooklyn, NY (US); Rachel Adler, New York, NY (US); Hannah Mussi, New York, NY (US); Naman Sehgal, New York, NY (US); Maxwell Shaw, New York, NY (US); Vinay Ramkrishnan, New York, NY (US); Andrew Lauria, New York, NY (US); Jacob Fancher, New York, NY (US); Taylor Takao, New York, NY (US)

(73) Assignee: Yext, Inc., New York, NY (US)

(21) Appl. No.: 18/177,066

(22) Filed: Mar. 1, 2023

(51) Int. Cl. G06N 5/022

(52) U.S. Cl. CPC G06N 5/022

(57) ABSTRACT

A system includes at least one processor, and a non-transitory computer-readable storage medium storing instructions which, when executed by the at least one processor, cause the at least one processor to perform a method that includes generating a knowledge graph having multiple nodes, each node including at least one field to store data, and being associated with at least one other node. The method further includes, at a particular node, defining a plurality of fields, such that a first field in the multiple fields has a dependence on a second field in the multiple fields. The method further includes receiving data at the knowledge graph, using the received data to define a value of the second field, using the value of the second field to generate a computed value for the first field based on the dependence, and updating the first field using the computed value.

### BACKGROUND

### 1. Technical Field

The present disclosure relates to content management systems, and more specifically to updating knowledge graphs.

### 2. Introduction

Content management systems are computer software used to manage the creation and modification of digital content. Knowledge graphs, which are one type of content management system, also known as semantic networks, represent connections between real-world entities, such as objects, events, situations, or concepts, by illustrating the relationship between them. This information is usually stored in a graph database and visualized as a graph structure, prompting the term knowledge “graph.” Knowledge graphs have three main components: nodes, edges, and labels. Any object, place, or person can be a node, which is identified with a label. An edge defines the relationship between the nodes.

### SUMMARY

Additional features and advantages of the disclosure will be set forth in the description that follows, and in part will be understood from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are methods, systems, and non-transitory computer-readable storage media which provide a technical solution to the technical problem described.

A method for a computer system can include: generating a knowledge graph having a plurality of nodes, each node comprising at least one field to store data, and being associated with at least one other node; at a particular node, defining multiple fields, such that a first field in the multiple fields has a dependence on a second field in the multiple fields; receiving data at the knowledge graph; using the received data, defining a value of the second field; using the value of the second field, generating a computed value for the first field, based on the dependence; and updating the first field using the computed value.

A system configured to perform the concepts disclosed herein can include: at least one processor; and a non-transitory computer-readable medium storing instructions which, when executed by the at least one processor, cause the at least one processor to: generate a knowledge graph having multiple nodes, each node comprising at least one field to store data, and being associated with at least one other node; at a particular node, define multiple fields, such that a first field in the multiple fields has a dependence on a second field in the multiple fields; receive data at the knowledge graph; using the received data, define a value of the second field; using the value of the second field, generate a computed value for the first field, based on the dependence; and update the first field using the computed value.

A non-transitory computer-readable storage medium configured as disclosed herein can have instructions stored which, when executed by a computing device, cause the computing device to: generate a knowledge graph having multiple nodes, each node comprising at least one field to store data, and being associated with at least one other node; at a particular node, define multiple fields, such that a first field in the multiple fields has a dependence on a second field in the multiple fields; receive data at the knowledge graph; using the received data, define a value of the second field; using the value of the second field, generate a computed value for the first field, based on the dependence; and update the first field using the computed value.

### BRIEF DESCRIPTION OF THE DRAWINGS

Further objectives and advantages will become apparent from a consideration of the description, drawings, and examples.

FIG. 1 shows a system of some embodiments.

FIG. 2 shows a process of some embodiments for updating a knowledge graph.

FIGS. 3A, 3B, and 3C show an example of content generation using a large language model (LLM).

FIG. 4 shows an example of computation support for slug options.

FIG. 5 shows an example of custom validation for slug options.

FIGS. 6A and 6B show an example of extracting geocodes from an address.

FIGS. 7A and 7B show an example of writing a blog post with AI computation.

### DETAILED DESCRIPTION

Various embodiments of the disclosure are described in detail below. While specific implementations are described, this is done for illustration purposes only. Other components and configurations may be used without parting from the spirit and scope of the disclosure.

All references cited anywhere in this specification, including the Background and Detailed Description sections, are incorporated by reference as if each had been individually incorporated.

As used herein, the term “external data sources” may include, but are not limited to, a websites, webpages, webhooks, video storage/distribution websites, social media platforms, content management systems, cloud computing resources, remote databases, and application programming interfaces (APIs). The ability to select a source of data and add that data to a knowledge graph may be referred to as a “connector.”

As used herein, the term “few-shot data cleaning” is a broad class of applications that involve using machine learning models to transform or modify text data given very few examples (hence the term, “few-shot”). Generally, “few examples” means “fewer than about ten.” As a non-limiting example, a model may be given three examples where lower-case text is converted to upper-case text (e.g., “a” to “A”). The model learns the transform given only the three examples. The model can then apply this transformation to any arbitrary text.

Transformation tasks are also often accompanied by a short description of the task, for example, “Convert each piece of text to upper-case.” The model being trained in this manner can be any machine learning model configured to operate in this manner. Non-limiting examples of machine learning models capable of operating in this manner include autoregressive language models using a transformer network for language prediction, such as the Generative Pre-trained Transformer 3 (GPT-3) model.

As used herein, the term “field automations” is an umbrella term for additional programmability offered by computed values, transforms, and validation at the field-level. Alternative terms include “programmable fields.”

As used herein, the term “computed (field) value” refers to a field value which is automatically populated based on a combination of inputs (e.g., other fields) and a selected computation (e.g., built-in or custom). Alternative terms include “programmable values,” “value sources,” and “value settings.”

As used herein, the term “computation” refers to, for a given computed value, the specific logic for how the value should be computed. This term is comparable to transform, in that a user selects from a list of built-in computations, or invokes a function for a custom computation. Alternative terms include “operation,” “calculation,” and “formula.”

As used herein, the terms “overwritable” and “read-only” refer to whether the computed value can be overwritten on a per-profile basis by a user. If a value is not overwritable, then the value is always computed, and is therefore read-only. In various embodiments, the default for a field may be either overwritable or read-only, and in some examples the user may toggle the default behavior between the two explicitly. An alternative term for “overwritable” may be “not read-only.” Alternatives also include “computed with overrides” and “pure computed.”

As used herein, the term “transforms” refers to any manipulation to the field data. Transforms take in the field value (in its state in the transform pipeline) and output a transformed version of the value.

As used herein, the term “validation” refers to rules which the field value must conform to in order to save successfully. For example, a validation may take in the value and return a Boolean value which indicates whether the value is valid or invalid.

As used herein, the term “test execution” refers to a mechanism for the user to test their field configuration with sample inputs. With a computed value, the input may be a sample entity. With a non-computed value, the input may be a static user-provided value. Alternatives include “preview sample,” “sample,” and “test sample.”

As used herein, the term “geocoding” refers to a mechanism to take in an Address and fetch the latitude and longitude (aka coordinates) of that address. These coordinates may then be used for syndication (Listings, rendering a map on Pages), as well as for search (geosearch).

The description next turns to the specific examples and embodiments, some of which are provided by the figures. Any of the various features discussed with any one of the embodiments discussed herein may also apply to and be used with any other embodiments.

Some embodiments automatically populate values in fields in a Knowledge Graph. These values may be computed using some combination of hardcoded rules (e.g., embeddings from other fields), requests to external systems (e.g., compute metadata, query coordinates for address), and employment of generative models to craft net-new content. These values may be computed per record (entity) across the Knowledge Graph, using other values on the record as inputs for the computation. The values may be applied directly onto the entity, or can flow through as suggestions, requiring another approval before the value is applied to the entity. Some embodiments provide a set of built-in “computations” which the user can select from, or the user can write custom code which will be run to compute the value. In addition, if new records (entities) are added and all dependent fields are included, the value may be recomputed without additional user action required. Some embodiments also are capable of triggering a computation in bulk across many or all records, for example, after a configuration change, so that all entities across the knowledge graph have the value recomputed based on the most recent configuration.

For example, a user could configure a computed value for a specific field across all entities in bulk. In one embodiment a user could configure the system to automatically write a biography for every entity that has that biography field. In other embodiments, it can be configured to only write biographies for certain fields that are enabled or a subset of entities, etc.

One technical problem that some embodiments address is that of content population at scale across a structured content management system. It is possible to run code outside of the core content management system to calculate values, and then populate these values on the records; however, it is challenging to do so. The solution of some embodiments defines the logic for how field values are computed when creating fields and making them available to records, and then ensures the relevant data on the particular record is employed when calculating the value in the relevant field for that record.

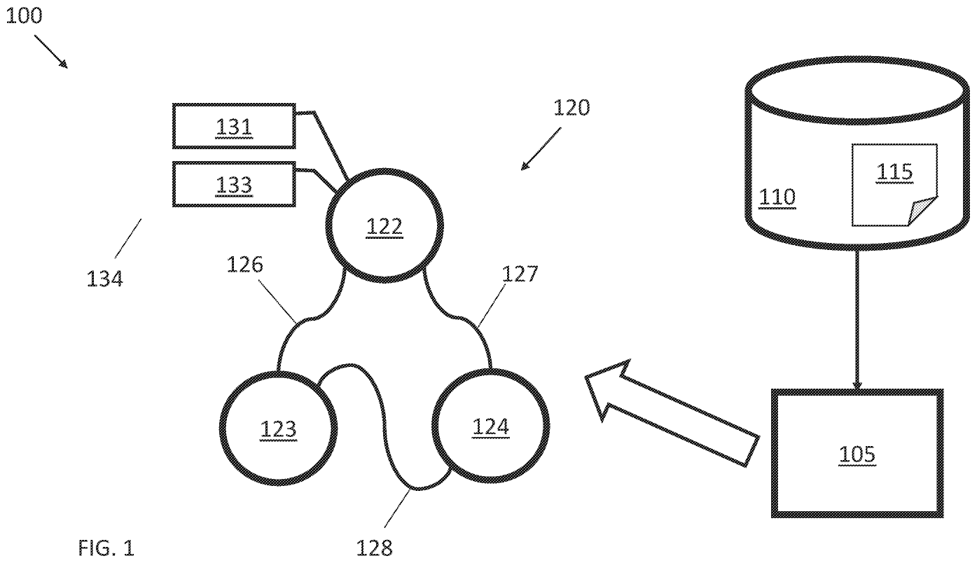

FIG. 1 shows a system 100 of some embodiments. The system 100 includes a processor 105 and a storage 110. The storage medium 110 stores instructions 115 which are executed by the processor 105. The system 100 also includes a knowledge graph 120 that has multiple nodes and edges. The knowledge graph 120 may be stored, for example, in the storage 110. Each node has at least one field to store data, and is associated with at least one other node. The associations between nodes are represented in FIG. 1 as edges between the nodes.

In the example of FIG. 1, the knowledge graph 120 is shown having at least three nodes 122, 123, 124. Node 122 is associated with node 123 via edge 126, and associated with node 124 via edge 127. Node 123 is associated with node 124 via edge 128. Generally, a knowledge graph 120 may have more or fewer nodes and edges than shown in this example, and the knowledge graph 120 in this example may have additional nodes and edges not shown.

Each node in the knowledge graph 120 includes one or more fields. For example, node 122 includes fields 131, 133, and the field 133 has a dependence on the field 131, as indicated by arrow 134. In some embodiments, due to the dependence of field 133 on field 131, the value of field 133 is dependent on the value of field 131.

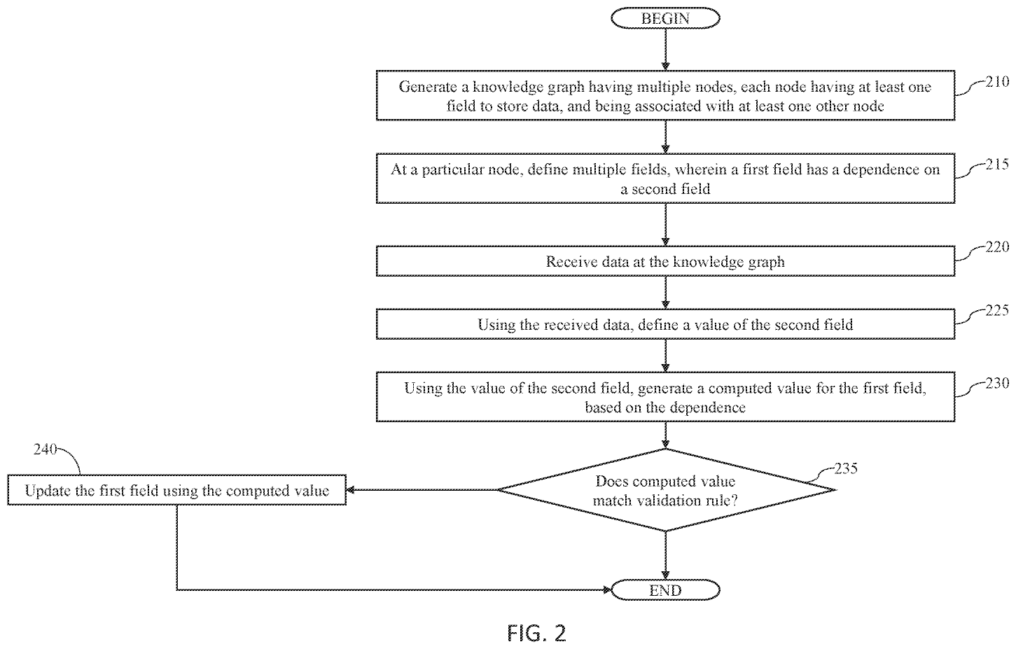

FIG. 2 shows a process 200 of some embodiments for updating a knowledge graph. In some embodiments, the knowledge graph may be the knowledge graph 120 described above with reference to FIG. 1, generated by the processor 105 and stored in the storage 110. The process 200 may, for example, be performed by the processor 105 in some embodiments.

The process 200 begins at 210 by generating a knowledge graph (e.g., knowledge graph 120) having multiple nodes, each node having at least one field to store data, and being associated with at least one other node.

At 215, the process 200 defines multiple fields at a particular node (e.g., fields 131, 133, at node 122). These fields are defined such that a first field (e.g., field 133) has a dependence on a second field (e.g., field 131).

Alternatively, in some embodiments, the knowledge graph may be received by the process 200, having been generated externally, and already have fields defined including the dependence between the first and second field.

At 220, the process 200 receives data at the knowledge graph. For example, in some embodiments, the data is received from a user. In some embodiments, the received data includes at least one of a profile or a template, that is used to define default values for one or more fields of the particular node.

At 225, the process 200 uses the received data, to define a value of the second field. In some embodiments, the value of the second field is defined by applying a profile to the second field. For example, the profile may specify a default value for the field in the absence of user input, or the field may be a read-only field.

In some embodiments, the value of the second field may be defined by applying a data model to transform at least part of the received data. As non-limiting examples, the transform may change the case of words, format numbers into phone number or scientific formats, or format text into dates or other structured data. The value of the second field is then defined based on the transformed data. In other words, the data model provides a mapping and a transform from the raw, received data to formatted, structured data that is compatible with the fields of the particular node.

At 230, the process 200 uses the value of the second field, to generate a computed value for the first field, based on the dependence. In some embodiments, the process 200 generates the computed value by performing an operation, such that the value of the second field is an input to the operation, and the computed value for the first field is an output of the operation.

In some embodiments, the operation performed by the process 200 may include a transform, such that performing the operation includes applying the transform to the value of the second field. For example, the transform may be applied to the value of the second field prior to using the value of the second field as an input to the operation.

Examples of transforms may include, but are not limited to, fixing capitalization (e.g., applying proper case or sentence case), find and replace strings of text with other strings of text, removing characters (e.g., whitespace, special characters, or numbers), extracting text (e.g., based on matching characters in a regular expression, or using offsets or delimiters), formatting dates (e.g., converting dates into alternate formats), and formatting times (e.g., converting times into alternate formats).

In some embodiments, the operation is defined by a user. In some embodiments, the operation is one of multiple (e.g., pre-defined) operations, and the process 200 further includes receiving a selection (e.g., by a user) of the operation from the multiple operations. Some embodiments may provide a combination of user-defined and pre-defined operations.

Examples of computations may include, but are not limited to, extracting geocodes from an address, content generation (e.g., using artificial intelligence (AI) or machine learning (ML) tools), custom functions, pre-defined functions, and custom AI or ML prompts.

In some embodiments, the operation includes generating a request to an external data source, such that the request includes the value of the second field. The operation provides the request to the external data source, receives a response from the external data source, and generates the computed value for the first field using the response from the external data source.

As a non-limiting example, the external data source may be a trained machine learning model, the request may be a prompt to the trained machine learning model, and the response may be an output of the machine learning model to the prompt. The machine learning model may be a large language model (LLM), for example. Examples of prompts may include, but are not limited to, writing a person's biography, writing a blog post or article, writing a business description, writing a review response, writing a social media post, writing a job description, and writing a press release.

As another non-limiting example, the external data source may be a database, the request may be a query to the database, and the response may be a reply of the database to the query.

As yet another non-limiting example, the external data source may be an application programming interface (API), the request may be an input to the API, and the response may be an output of the API to the input.

At 235, the process 200 performs a validation on the computed value. The validation may be at least one rule, to which any value of the first field must conform. If the computed value matches the rule, then the process 200 proceeds to 240, which is described below. If the computed value does not match the rule, then the process 200 ends.

Examples of validations may include, but are not limited to, character length (a maximum, a minimum, or both), regular expression validation, and uniqueness enforcement.

At 240, the process 200 updates the first field using the computed value.

Alternatively, in some embodiments (not shown in FIG. 2), the process provides the computed value, for example, to a user as a suggested value. If a confirmation is received, then the process 200 updates the first field using the suggested value (e.g., the computed value), and the process 200 ends. If there is no confirmation, then the process 200 ends.

In some embodiments (not shown in FIG. 2), the process 200 further receives an indication at the node in the knowledge graph, and updates the first field in response to receiving the indication. As an example, the indication may be from a user, as an on-demand update to the first field. As another example, the indication may be triggered by a change in a value of at least one other field. The other field may be the second field (e.g., the field upon whom the first field has a dependence). Alternatively, the other field may be a field upon whom the first field has no dependence. As yet another example, the indication may be triggered automatically after a period of time (also referred to as a cadence).

In some embodiments (not shown in FIG. 2), the process 200 also defines additional fields at additional nodes that are associated with the particular node, and further updates a field of another associated node, based on the computed value.

In some embodiments (not shown in FIG. 2), the process 200 also provides the computed value for the first field as an input to one or more operations, and then performs the operations to generate one or more corresponding outputs. As a non-limiting example, if the computed value is a person's biography, then the operations may be updating multiple websites or directories (e.g., one operation per website or directory), and the corresponding output of these operations would be the individual webpages or directory entries associated with that person, updated with that new biography information.

In some embodiments, the knowledge graph (e.g., knowledge graph 120) may have associations with external data sources, including but not limited to local “first-party” sources stored in storage 110 (or other storages) of system 100 (e.g., databases, pages, webpages, files, etc.) and other “third-party” sources external to system 100 (e.g., third party publisher sites, external databases, APIs, etc.). When a computed value is used to update a field in the knowledge graph, the system 100 may propagate the computed value to such first-party and third-party sources.

As an example, consider a node corresponding to a person who is a financial advisor for a nationwide firm, and fields associated with that node include an office location (e.g., New York) and hobbies (e.g., Cycling). A biography field may be a computed field that has a dependence on these fields.

If the person's hobbies change (e.g., if they also desire to add Fishing as a new hobby), then these changes may cause an automated or triggered update to the person's biography. If that biography is part of the firm's web pages for the New York office, the biography for the advisor on the New York office pages may change.

If the person transfers to the firm's Connecticut office, then again, the biography is updated as before, and in addition, the financial advisor's information (including the biography itself) may automatically be added to the firm's web pages for the Connecticut office. In addition, the bios may also be updated on firm-affiliated or personal listings on third party sites such as a search engine business page (e.g., Google Business), a review site (e.g., Yelp), etc.

Some embodiments provide a platform to extend core functionality of a knowledge graph via pre-built libraries as well as custom code, allowing complex logic to be built into an ingestion pipeline. This provides advantages over using webhooks to invoke functions, the functions being expected to interact with the public REST Knowledge API endpoints for any data manipulation. The Webhooks+Functions architecture is not sufficient for certain cases, in part because of the execution sequence of this flow. Specifically, a webhook fires after an event has completed and some underlying set of data has changed; any changes then made by the invoked function will be subsequent, separate changes to the underlying data. This execution flow results in data entering an undesired state for at least some period of time. Ideally, the programmatic extension would occur in the critical path of the update.

Additionally, there are some common operations for which custom code is cumbersome; these operations include applying templates, creating language profiles, and validating field values using pattern matching like Regex.

Finally, the Functions+Webhooks workflow may result in an infinite loop, as the webhook is used to invoke the function, and the function then updates an entity, triggering another webhook, triggering another invocation of the function. This infinite loop is avoidable.

### Exemplary Use Cases

In order to better understand the cases in which it is crucial to be able to extend the critical path of operations programmatically, several use cases are now described, followed by proposals of potential solutions provided by some embodiments. These use cases are grouped by the resources which they concern (field, entity, profile, suggestion).

### Field-Level

### NPI Validation

National Provider Identifiers (NPIs) for Healthcare Professional entity types must be validated before uploading these entities to a knowledge graph. This may be done in some embodiments by running a script which interacts with the National NPI Registry to validate the provided NPI.

In some embodiments, validation for field values is achieved within the platform, as opposed to offline. For any validation which requires complex logic and/or to interface with some external API, extending field validation with serverless functions may be desirable.

### Slug Fields

In some examples of Headless Content Management Systems (CMSs), the Slug field is the extension of the base URL which is stored on the record itself, and may be used as the URL for the relevant webpage. Slugs typically meet the following set of requirements:
1. Unique within the account. No two records can have the same value for the slug field.
2. URL-safe
3. Required on all records
4. Localized

Built-in field types can support this level of control, without explicitly requiring being extended using functions. However, if more complex Slug requirements exist per customer, some embodiments may extend fields of this type with additional validation (be it custom via Functions or built-in) to meet the requirements.

### Geocodes

The geocoding behavior in some embodiments of a knowledge graph may be thought of as functioning like a field-level “automation” such that providing a value for the built-in Address field results in that address being sent to an external server to produce coordinates. In some embodiments, this complexity can be exposed and offered as an extensible option for any address field. To create a coordinate field, that field may be set as “computed” using another address field and a built-in “geocode” automation.

### Healthcare Conditions Specialties

In some healthcare embodiments, the “taxonomy” setup has providers (Healthcare Professional) linked to Specialties linked to Conditions, and this linking is used to produce the list of conditions treated for a given provider. However, there is a somewhat common scenario in which a single provider (Healthcare Professional) may treat a slightly different set of conditions than indicated by their specialties.

For this scenario, some embodiments set a computed value (something like {{linkedSpecialties.treatedConditions.name} }) as the initial value for the field, which may result in a copy of the list directly onto the profile, which can then be modified in-line.

### Financial “Annual Review”

Financial organizations are required by regulations to review data on an annual basis. A custom solution of some embodiments to fetch Entity History via API may be performed at some cadence; for example, if a (field, entity) pair has not had an update in the past year, the custom solution may create a suggestion for that field value, effectively creating that “review” task. However, this may be an expensive programmatic calculation, by looping through all fields in the account for all entities to determine which (field, entity) pairs require review.

Some embodiments provide an automated solution to handle triggering a “review” once a field's data has remained stagnant for one year.

### Pages Meta Titles and Descriptions

Meta titles/descriptions are often the same for every location, for example, “Visit your local [[name]] at [[address.line1]] in [[city]], [[regionCode]] for high end skin, hair, scrubs, etc.”. In some embodiments, these may be populated by some default field value, and then be able to override that per entity.

### ML-Based (e.g., GPT-3) Content Generation

When defining a field, some embodiments may automatically generate the value using a large language model (LLM) like GPT-3. For example, some embodiments generate descriptions for Financial Advisors using field values on the entity and a written task description.

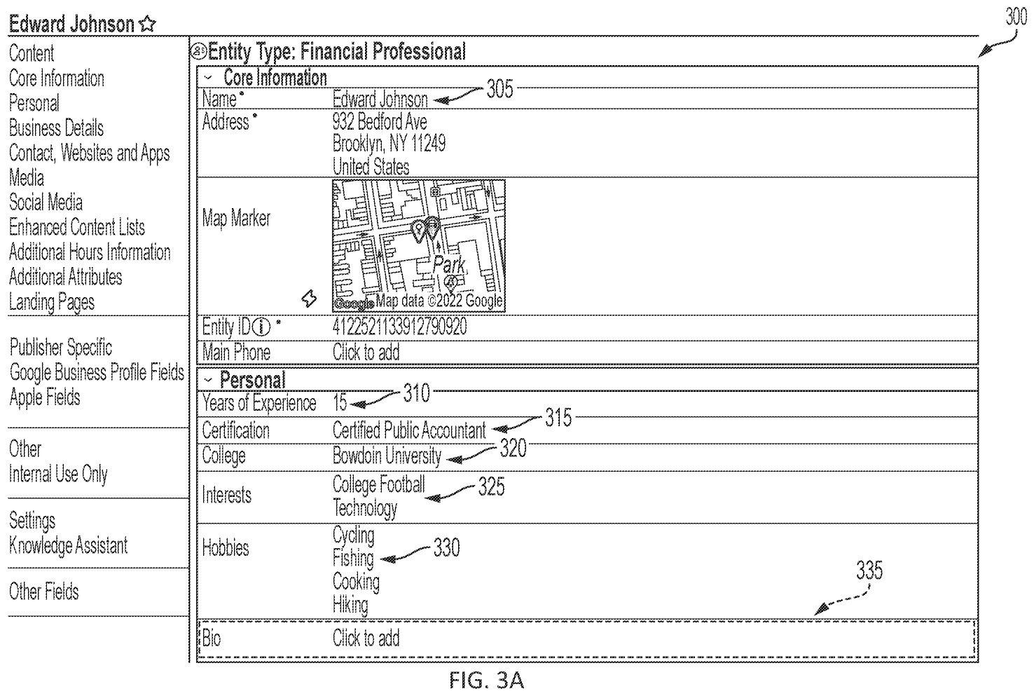

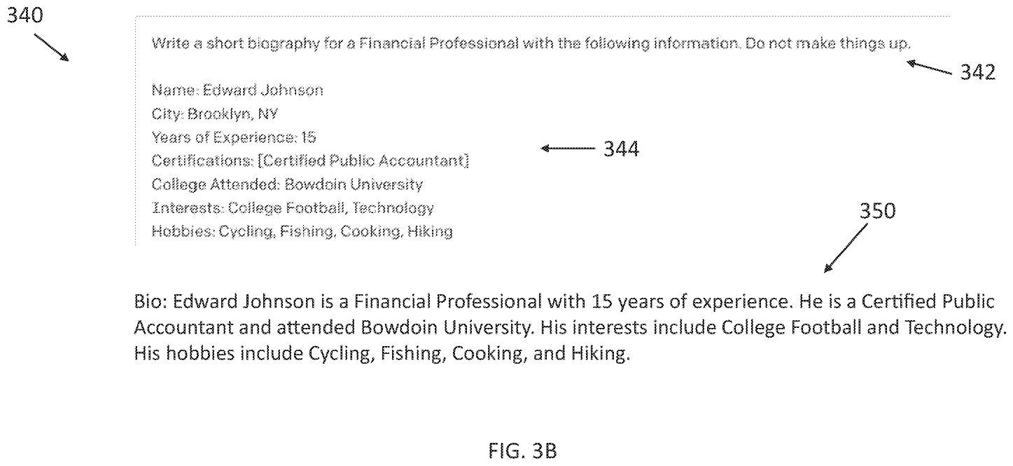

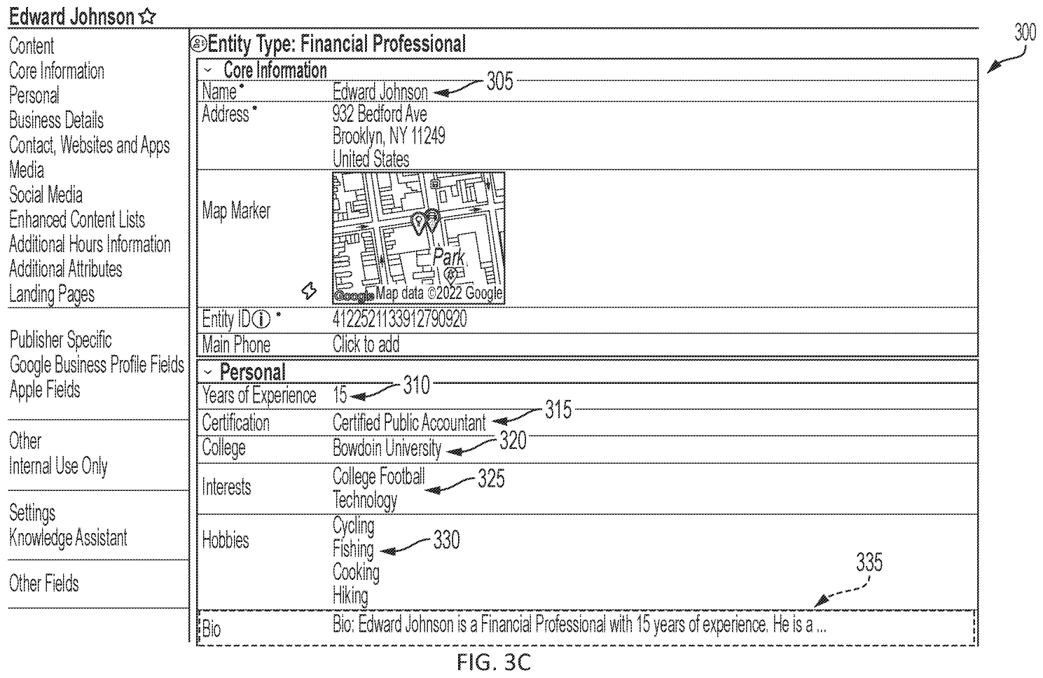

FIGS. 3A, 3B, and 3C show an example of content generation using a large language model (LLM). FIG. 3A shows a node 300 corresponding to a financial professional named Edward Johnson, with several fields, including a name field 305, a years of experience field 310, a certification field 315, a college field 320, an interests field 325, and a hobbies field 330.

The node 300 also includes a biography field 335 which is dependent on fields 305-330. After receiving data for fields 305-330, an indication is received to generate a value for the biography field 335. In this example, the biography field 335 initially has no value, and the indication is from a user, by clicking the text “click to add” in the otherwise empty biography field 335. In some embodiments, the indication is a trigger that occurs when at least one of the source fields 305-330 are updated, or at a specified cadence (e.g., a pre-defined interval of time).

In some embodiments, the biography field 335 may be associated with metadata (not shown) that indicates the source or type of the value (e.g., “computed”), a selected computation (e.g., “Write an advisor bio with AI”), and a list of the input fields.

FIG. 3B shows a prompt 340 generated as an input for a LLM. The prompt includes a directive 342, as well as additional data 344 populated from the fields 305-330 of the node 300. The prompt 340 is used as input to the LLM, which generates an output 350. The output 350 may be referred to as a computed value.

FIG. 3C shows an updated node 300, where the output 350 is used as the value for the biography field 335.

### Entity-Level

### Applying Templates on Entity Creation

In some embodiments, the process of applying templates on entity creation can be applied manually, or by using functions which are invoked by webhooks. One limitation of the webhook approach is that it requires logic to be maintained in code to determine the criteria which should result in various templates being applied. Accordingly, some embodiments provide a mechanism to automatically apply templates.

### General Reliance on Connectors for Server-Side Logic

Connectors provides an interface in some embodiments for server-side logic before ingesting data to a knowledge graph. This functionality may be extremely useful; however, entities will inevitably be created (as well as updated and deleted) in non-Connectors interfaces (Entities API, UI, Upload).

A more comprehensive approach provided in some embodiments allows to associate automations (built-in and/or custom) with the knowledge graph event itself, rather than requiring updates which use server-side logic to leverage connectors.

For example, if a template is to be applied to entities of a certain type, it is preferable to associate this operation with entity creation, rather than only being able to associate it with connector runs.

Similarly, for first party reviews, it is desirable to have custom logic for processing the submitted entities; for example:

The entity matches a certain type.

(In some cases) the entity has a valid (unique within the account, and legitimate according to an external invitations system) Invitation ID, to ensure that only “invited” end-users can leave a review.

If it contains a certain word or has a certain rating, it flows to a specific approval group as a suggestion.

Some embodiments leverage a push connectors API to handle this logic. Other embodiments associate the logic with the knowledge graph event itself (e.g., Entity Create/Update/Delete), which would ensure that regardless of the interface from which the entity was managed, the logic would execute.

### Entity “Verification”

Similar to the field example above for financial organizations, in the Knowledge Base space, it is common for an entity to require manual review if it has not been updated after some period of time. This may be referred to in some embodiments as “verification”. In some embodiments, at the granularity of an entity type, users may configure automations to run on a time-based cadence.

### Directory Manager

Some embodiments provide a “Directory Manager” to handle creating and managing a set of related entities according to standard configuration in order to create a “directory” structure. The Directory may be thought of as an “entity-level” automation.

### Data Science Opportunities

In some embodiments, a number of Data Science driven use cases are also potential automations.

Duplicate Detection. For example, some embodiments provide a technique for detecting duplicates. The model takes in a set of fields which should be used for comparison, compares all entities of a selected type (or set of types), and determines the likelihood that two entities are duplicates. The system is best positioned to run on some cadence asynchronously. In such embodiments, the specifics of the comparisons may include but are not limited to:
Entity Types;
Fields;
Weights per field;
Duplicate Threshold;
Behavior when a duplicate is detected; and
Cadence.

FAQ Generation. As another example, some embodiments provide a technique for generating Frequently Asked Questions (FAQs). Some embodiments provide a model which generates questions (but not answers) given some set of data. This model may be leveraged in the ingestion pipeline (i.e., from a crawled site). Other embodiments analyze a knowledge graph on some cadence to generate FAQs.

Avoiding Jagged Profiles. Some embodiments enforce that on entity-creation, some set of alternate language profiles are created.

### Profile-Level

### Applying Templates on Profile Creation

The jagged profiles problem may be avoidable using Functions, as noted above. However, upon creation of these profiles, a template may also be applied. There are a few problems with relying on Webhooks+Functions for this use case:

In some embodiments., saved filters may be calculated at the entity-level, not at the profile-level. Therefore, a newly created profile which does not meet the Saved Filter criteria may be included in the stream, regardless of whether the profile individually would meet the saved filter criteria. Therefore, the data being in the interim state (between creation and webhook+plugin execution) can result in the profile being included downstream—in Sites specifically, this can cause build failures.

### Suggestion-Level

### The Suggestion Routing Problem

Some embodiments provide custom “routing” for suggestions to allow businesses to write logic for which users/user groups suggestions are assigned to, whether suggestions require multiple levels of approval, etc.

As an example, for Financial Services customers, custom code may be maintained which interacts directly with the Suggestions RPC Endpoints to support routing logic and multi-level approvals.

Some embodiments introduce more invocation points for various knowledge graph “automations”; these automations may be invoked in the critical path of the relevant update, meaning the update would not apply until the automation had executed.

Some embodiments provide the following invocation points, and built-in automations, as described below in Table 1, Table 2, and Table 3.

TABLE 1
Field-level

| Invocation Points | Relevant Built-in Automations |
|---|---|
| Field Save (aka custom | Regex Validation |
| validation) | Enforce Universal Uniqueness |
| | Connectors-style manipulations, such as: |
| | Fix capitalization |
| | Find and replace |
| | Remove chars |
| | Etc. |
| Computed Field | Embed other fields (defined at field |
| | definition instead of per entity) |
| | AI/ML (GPT-3) Generated Content |
| | Geocode |
| (Time Based) Field | Create Verification Task (i.e. Suggestion) |
| Value “Verification” | |
| Default Values | Embed fields (from entity or linked entity) |

TABLE 2
Entity-level and Profile-level

| Invocation Points | Relevant Built-in Automations |
|---|---|
| Entity Creation | Apply Template |
| | Create Alternate Language Profiles |
| Profile Creation | Apply Template |
| (Time Based) Entity “Verification” | Create Verification Task |
| | (i.e. Suggestion) |
| KG “Analysis” (probably using | Create an Entity Suggestion (New |
| AI/ML to analyze a given KG, | Entity or Deleted Entity) |
| likely at some cadence) | |

TABLE 3
Suggestion-level

| Invocation Points | Relevant Built-in Automations |
|---|---|
| Suggestion Created | Approve/Reject/ |
| Suggestion Approved/Rejected/Reassigned | Assign/Comment On |
| Suggested Content Updated | Suggestion |
| Time Since Suggestion > N | |

Associating Invocation Points with Automations

A feature's interface may be leveraged in some embodiments to associate the invocation points with the relevant automations. In order to support more invocation points, a method may be used to associate a given invocation point with the relevant “automation” (be it a Function or a built-in operation).

In some embodiments, there may be two options for the various Automations it is desired to support:

1. A unified interface for associating Invocation Points with Automations. This may be a configuration flow, plus a table, with all associations. This approach may imply that these are a single Configuration as Code (CaC) Resource Type for Automation, which is leveraged for all automations.

2. Utilize the area's native interface to associate invocation points and automations.

A third option is a hybrid of the two approaches, in which automations can be configured within relevant interfaces when useful, but there is also a more centralized option for viewing and managing these automations.

### Product/Development Approach

In some embodiments, the field-level and entity-level invocation points are a priority. At the field-level, the most important built-in automations to support may be custom field validation using regex and computed field values. At the entity-level, the most important built-in automations may be template application and profile creation. However, these priorities could change; for example, using Suggestions for the FINS Reviews use case could make solving routing in a more first-class way a higher priority.

### Computed Fields

Some embodiments use “computed fields”; these computations may be defined at the Field Definition Level, or at the Field-level on a particular entity. Users may select their computation from a built-in library of transforms or write their own custom code running on Functions.

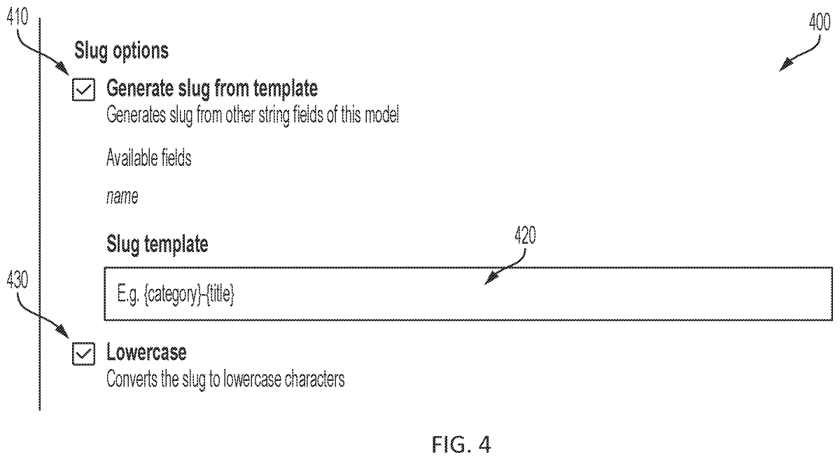

An example of a problem this would address is Slug field+localization. The Slug field definition would be [[slug]]+profileLanguage, for example. FIG. 4 shows an example of computation support for slug options. A user interface 400 provides an option 410 to use a template 420 to generate the slug, and a transform 430 is used to convert the slug to lowercase characters.

### Custom Validation

In some embodiments, users could write some custom validation as part of their field definition, which would extend the validation supported for each field type today. This validation could also be made up of a library of built-in validation and custom code running on functions.

### Built-In Examples:

Regex validation for value (Could be match or does not match);
Enforce uniqueness (Value cannot be used across multiple profiles); and
Default values (Field could be initialized to always have a default value).

### Trigger Examples:

On-Save—This would be the standard for custom validation—it would fire every time the field is saved.
Time-based—If a field had not been updated for some period of time, then trigger validation.

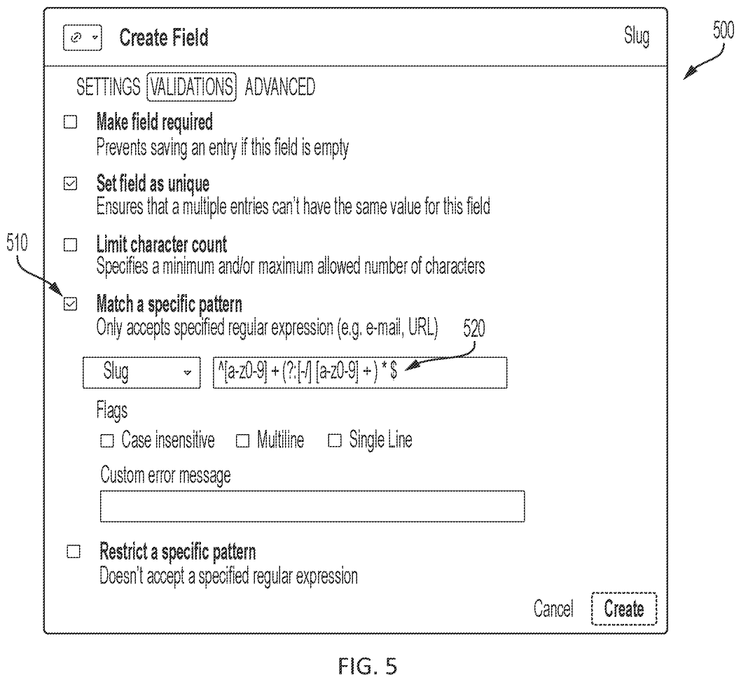

An example of a problem this would address is enforcing uniqueness amongst slug fields. FIG. 5 shows an example of custom validation for slug options. An interface 500 provides an option 510 to match a specific pattern, which is defined by a rule 520 (in this example, a regular expression).

### Overview: Field Automations

### Knowledge Graph

Some embodiments provide maximum flexibility by supporting programmatic extensibility. A common implementation pattern for extending the platform is via Webhooks+Functions; however, in many cases, it is important to provide more first-class invocation points for automations. Some or all of the following circumstances are typically motivating factors in introducing this first-class “automation” support:

In some embodiments, what is herein referred to as “Field Automations” may be composed of three independent components, listed in Table 4.

TABLE 4
Components of field automations

| Component | Definition | Input | Output |
|---|---|---|---|
| Computed | A field value which is automatically | Entity Profile | Value |
| Value | calculated based on a combination | | |
| | of inputs (other fields) and a selected | | |
| | computation (built-in or custom). | | |
| Transform(s) | The component which handles | Value | (Transformed) |
| | manipulating the field data. | | Value |
| Validation(s) | Rules which the field value must | Value, Profile | Boolean |
| | conform to in order to save | (Optionally) | |
| | successfully. | | |

In different embodiments, these three components can be leveraged individually, or all three can be leveraged together. When a field is programmed, the following may be considered:

How is the value populated? In various embodiments, this includes but is not limited to: (a) user provides a value per-profile, and (b) system computes the value automatically. Considerations include, how the value should be computed, and whether users may overwrite the (computed) value on a per-profile basis.

Should the value be transformed?
Should the value be validated?

These three features may be independently valuable, and generally can be considered as discrete projects. They are grouped here for conceptual clarity since they are closely related, but in some embodiments each feature may be implemented separately.

### Computed Field Values

In some embodiments, an embed key is specified so that the value is actually composed of other field values on the profile. In some embodiments, a value must be populated at the profile-level. Bulk update mechanisms may also be present (e.g., API, Upload, Connectors).

Computed values are the alternative in some embodiments to existing, user-provided values. This allows the definition of automation logic for how the value of a given field is populated. This logic is defined at the field-definition-level. With computed values, the value on a per-profile basis is automatically generated based on the computation selected for that field. Computations may have access to the full context of the profile, including metadata about the entity and profile (entity type, locale), as well as the full body of the entity.

For example, when configuring a computed value, the user may select a configuration as shown in Table 5.

TABLE 5
Configurations - definition and behavior

| Configuration | Definition/Behavior |
|---|---|
| Computation | How the value will be computed. A library of |
| | built-in computations maybe provided, or a |
| | Serverless Function invoked. |
| Read-Only vs. | Whether the value can be overwritten on |
| Overwritable | individual profiles or is always computed. |
| | Read-Only: The field value will always be |
| | calculated automatically. In Entity Edit, the |
| | value is not editable. |
| | Overwritable: The field value will be |
| | calculated automatically. However, a user can |
| | overwrite the value on a given profile. |
| Apply as Suggestion | Whether the computed value should be |
| | applied directly to the entity, or should be |
| | created as a Suggestion. |
| | This functionality is important for use cases |
| | where the computation is not |
| | authoritative/deterministic - for example, the |
| | AI Generated Content cases. |
| Compute Cadence | Some computations will automatically |
| | regenerate when a source field is updated; if |
| | the embedded field is updated, then the |
| | rendered value for the field with the |
| | embedding is updated accordingly. |
| | For other computations, a cadence may be |
| | used if the computation is expensive (for |
| | example, AI Generated Content), or if the |
| | computation references an external source. |
| Per-Profile | different computations may be provided per |
| Computation | profile |
| | For example, for the slug field, the locale may |
| | be appended if and only if the profile is an |
| | alternate language profile. |
| Per-Entity-Type | Similar to per-profile computations, per- |
| Computation | entity-type computation logic might also be |
| | provided. |

### Example Built-in Computations

Some embodiments provide a library of built-in computations, in addition to support to invoke a Serverless Function. Following are some examples of built-in automations that may be supported in some embodiments.

Static Value (with Optional Embeds)

Alternate Names: Default Value. Pre-set value.

An example use case is setting a static value at the field definition-level. This outcome could be achieved by embedding a field on each entity, but doing so may require ensuring that the field value is properly set for all entities. Providing support for default values will streamline the content management experience, especially for fields which commonly have values derived from other fields.

Example Use Cases include but are not limited to: slug Field, any other field which is currently derived from embeds using a consistent “formula,” and default values.

Extract Geocodes from Address

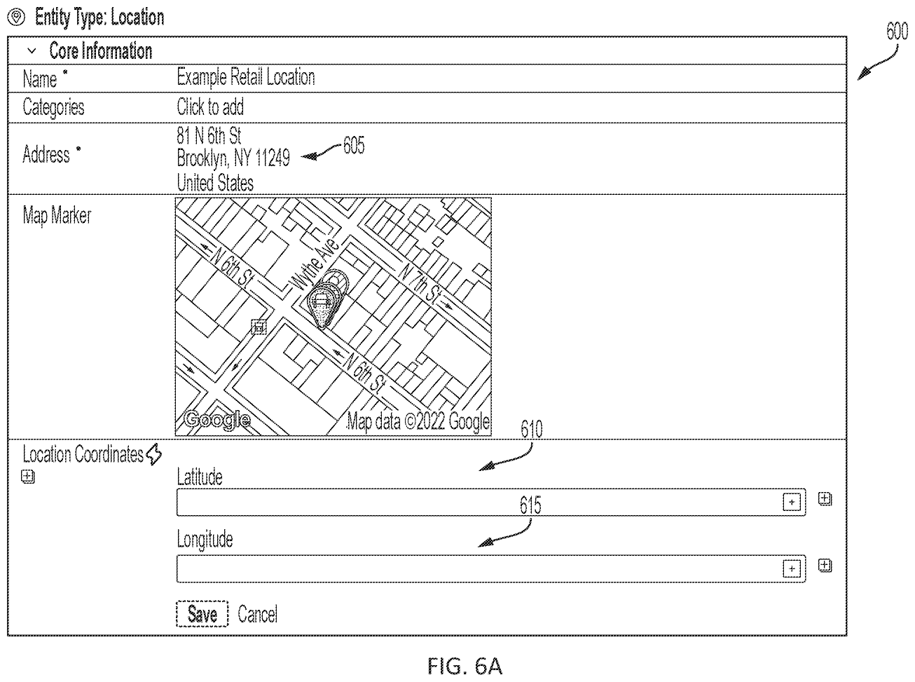

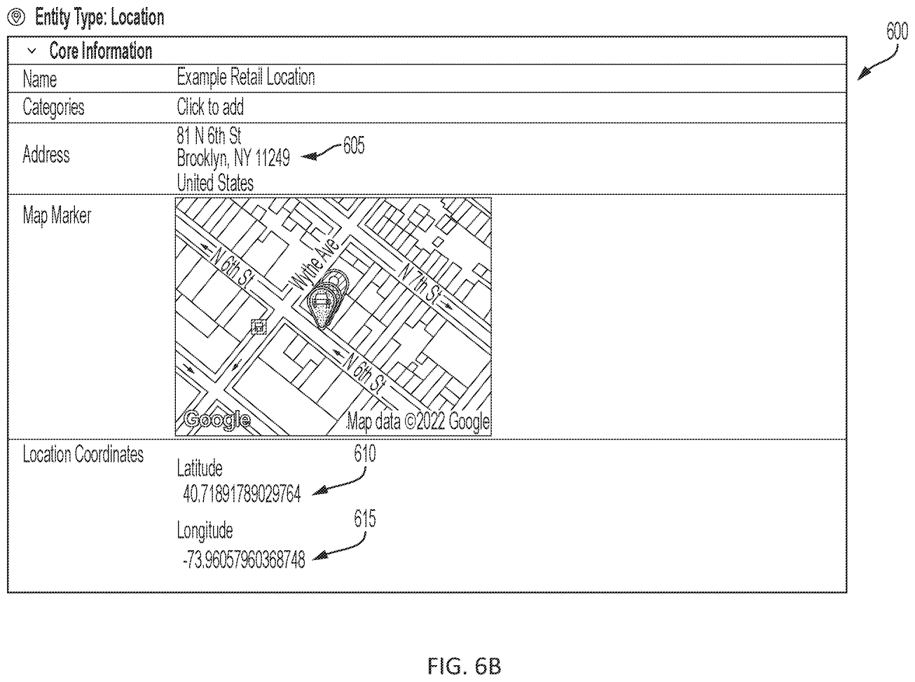

FIGS. 6A and 6B show an example of extracting geocodes from an address. FIG. 6A shows a node 600 corresponding to a retail location, with several fields, including an address field 605. The node 600 also includes geocode fields, namely, a latitude field 610 and a longitude field 620, both of which are dependent on address field 605. After receiving data for address field 605, an indication is received to generate values for the latitude field 610 and the longitude field 620. In this example, the geocode fields initially have no value, and the indication is a trigger that occurs when the address field 605 is updated. In some embodiments, the indication is received by a user prompt, or at a specified cadence (e.g., a pre-defined interval of time).

In some embodiments, the latitude field 610 and the longitude field 620 may be associated with metadata (not shown) that indicates the source or type of the value (e.g., “computed”), a selected computation (e.g., “Extract geocodes from address”), and a list of the input field(s).

The value of the address field 605 is provided as an input to an external system (not shown) for converting addresses to geographic coordinates. The external system provides an output in the form of a latitude value and a longitude value, which are used as the values for the latitude field 610 and the longitude field 620. FIG. 6B shows the node 600 with the latitude field 610 and the longitude field 620 having been updated with the computed values from the output of the external system.

Extract Information from Photos Files

metadata extraction may be provided for different file types; for example, video length and/or transcript extraction, PDF length, width and height of the photo etc.

In some embodiments the user selects a computation which computes information from the source field where the file is stored. This model also ensures that having a different schema per file type is not always necessary, since it's simple to have a base schema for the file, and then allow metadata to be computed into user-defined fields separately.

Generate Content with AI

One advantage of some embodiments is to not only organize and manage existing content, but also generate net-new content. By using generative models like GPT-3, some embodiments can use a combination of existing data and prompts to generate net-new content.

### Field Last Updated Date

In some embodiments, the last updated date for a specific field on the entity may be computed. This information is useful for determining “freshness”, as certain fields may need to be updated at some cadence.

### Field Last Updated By

Some embodiments automatically compute the system which last updated a field value.

### Invoke a Function

Some embodiments support the ability to invoke a function directly as the computation for a particular computed value.

### Find Nearby Locations

Some embodiments allow customers to link to nearby locations, and also have this list of nearby locations remain up-to-date. For example, this computation is useful where each destination page showcases the set of nearby locations.

### Find Root Entity

For deeply nested entities, especially those with a hierarchical structure, some embodiments determine the root entity, which means traversing “up” the tree to find an entity with no other parents. For example, in some embodiments, this is achieved by defining the field path to traverse (i.e. only look at the c_parents field) as well as the criteria if there are multiple linked entities at each level (for example, find the longest chain).

### Add Owner

Some embodiments provide a built-in automation which writes the user who creates the entity to a field, and also handles things like fallback logic if that user is deleted.

### Find Related Entities aka Graph Generation

Some embodiments automatically compute a graph, relating relevant entities using

ML/AI capabilities. In this example, the field would be of type relationship, and the computation would be “Find Related Entities”; the ML/AI models determine which entities might be related to a given entity, and populate those entities.

Reference from Linked Entities

Some embodiments support accessing related entity content via embeddings.

### Aggregate Across Linked Entities

Some embodiments provide aggregations across linked records or entities.

### Transforms

In some embodiments, transforms provide an interface to insert logic which modifies the value before it is saved to the profile. Transforms may not be tied to computed values in any meaningful way; rather, the transform simply operates on the value as received. More specifically, the value may be provided by a user or computed automatically.

### Validation

Some embodiments support for validation, including more built-in validation options, as well as the ability to extend validation by invoking a function directly.

Some examples of the validation include but are not limited to:
Regex Validation;
Universal uniqueness;
NPI Validation; and
Invoking a function.

### Examples

Some example use cases are:

TABLE 6
Slug fields

| | Type | Logic/Params |
|---|---|---|
| Computations | Static Value with | [name]]-[city]/[locale]] |
| | Embeds | |
| Transfor- | Find and Replace | Replace spaces with dashes |
| mations | Fix Capitalization | All lower case |
| | Find and Replace | Replace all sequential special |
| | | characters with a single dash |
| | Find and Replace | Strip dashes from front and |
| | | end of string, strip all other |
| | | special chars |
| | Find and Replace | If primary exists, replace with |
| | | blank |
| Validations | | |

TABLE 7
Geocodes fields

| | Type | Logic/Params |
|---|---|---|
| Computations | Extract Geocodes from | User selects single field of |
| | Address | type address from which |
| | | geocodes are extracted |
| Transformations | None | |
| Validations | None | |

TABLE 8
Find Nearby Locations

| | Type | Logic/Params |
|---|---|---|
| Computations | Find Nearby Locations | Select field on which |
| | | geosearch should be |
| | | performed |
| | | In this example, the name of |
| | | the entity is the city, so this |
| | | should be a valid param. |
| Transformations | Filter Rows | Remove results with name |
| | | including “Closed” or |
| | | “CLOSED” |
| Validations | | |

TABLE 9
Generate Meta Description

| | Type | Logic/Params |
|---|---|---|
| Computations | Generate Meta | Select the fields to be |
| | Description with AI | included as inputs. For |
| | | example, Name, Address, |
| | | City, Categories |
| | | Configure other |
| | | configurables. Such as: |
| | | Tone |
| | | Length |
| Transformations | | |
| Validations | Character Limit | Some max length |

TABLE 10
Validate NPI for Healthcare Professional

| | Type | Logic/Params |
|---|---|---|
| Computations | None | |
| Transformations | None | |
| Validations | Invoke a Function/Use | Hit the NPPES API with the |
| | Built-in NPI | NPI provided. Compare the |
| | Validation (if built) | result to the name of the |
| | | Healthcare Professional. If |
| | | names match well enough, |
| | | valid, else, invalid. |

### Computed Field Values

Knowledge graphs (KGs) are a flexible, graph-oriented content management system; compared to more classic CMS systems, KGs provide the functionality for businesses to organize their data in a manner aligned with their internal information architecture, in contrast to being forced to organize data as it will be reflected on their website, as a single record per page.

The vision for KG is to provide functionality which enriches customer data, rather than simply serving as a content storage layer. Specifically, there is an opportunity to enrich content at scale, by leveraging the existing primitives of Knowledge Graph, such as fields, field types, and suggestions.

### Project Scope

Some embodiments include Computed Field Values, field-level data transformations, and more extensible validation for field values. Some embodiments provide the ability to configure logic per field to automatically populate content as the fields' values. This functionality is referred to as Computed Field Values. See Table 11 for term definitions.

TABLE 11
Definitions

| | Alternative Names | | |
|---|---|---|---|
| Term/Concept | to Consider | Definition | Behavior |
| Computation Method | Computation | The way in which a | Some embodiments |
| | Computation Logic | value will be | provide an ever- |
| | Computation Strategy | computed. For | growing number of |
| | | standard, non- | built-in computations. |
| | | computed values, the | Customers may also |
| | | method will simply | be able to write their |
| | | be set to None. | own custom |
| | | | computations using |
| | | | functions. |
| Read-Only vs. | Read-Only: Pure, | Whether a computed | By default, values |
| Overwritable | Strict | value can be edited | will be overwritable |
| | Overwritable: | by the end-user, or is | per profile. |
| | Modifiable, Editable, | always read-only. | Optionally, users can |
| | Read/Write | | make their values |
| | | | read-only, which will |
| | | | restrict users from |
| | | | editing the field value |
| | | | directly. |
| Suggest Value | | Route the computed | Not default behavior. |
| | | value through as a | May not work with |
| | | suggestion, rather | read-only values (see |
| | | than applying it | below). |
| | | directly to the profile. | |
| Inputs | Parameters | The inputs which the | In some |
| | | computation method | embodiments, built-in |
| | | accepts. | computations have a |
| | | | set of inputs that they |
| | | | will receive, which |
| | | | the user populates |
| | | | when configuring the |
| | | | value's computation |
| | | | method. These inputs |
| | | | may be some |
| | | | combination of fields |
| | | | and static |
| | | | instructions. Inputs |
| | | | can be required or |
| | | | optional. |
| Field Dependencies | | Each field included | Any field used for a |
| | | as an input has | required input may |
| | | dependency levels, | have a computation |
| | | which inform if/when | dependency. |
| | | the value will be | Any field used for an |
| | | computed on a | optional input can |
| | | particular profile. | have the Computation |
| | | There are at least two | Dependency set to |
| | | types of | true. |
| | | dependencies: | Any field can have a |
| | | Computation | Recomputation |
| | | Dependency - the | Trigger set to true. |
| | | field's value must be | |
| | | populated on a profile | |
| | | for the computation | |
| | | to occur. | |
| | | Recomputation | |
| | | Trigger - the field's | |
| | | value changing will | |
| | | trigger a | |
| | | computation. | |
| Recompute Cadence | | The cadence on | Unset by default in |
| | | which the value | some embodiments. |
| | | should be | If the computation |
| | | regenerated. | logic is unaware of |
| | | | dependencies, some |
| | | | embodiments |
| | | | recompute the value |
| | | | on a cadence instead. |
| Test Execution | Test Output | Test the execution of | For Computed |
| | Test | the field definition | Values, the user may |
| | View Sample | with a sample set of | select a sample |
| | Sample Execution | inputs. | “input” entity, have |
| | | | the computation |
| | | | executed, and can see |
| | | | the output. Allows |
| | | | the user to iterate on |
| | | | their computation |
| | | | before deploying it |
| | | | across KG. |
| Deterministic vs. | | Whether the given | Specified at the |
| Non-Deterministic | | computation will | computation-level. |
| | | always produce the | May have some |
| | | same output given the | implications on the |
| | | same inputs | UX. |
| | | (deterministic) or | |
| | | may produce a | |
| | | different output each | |
| | | time, with the same | |
| | | inputs (non- | |
| | | deterministic). | |

Computed vs. Traditional Field Values

Traditionally, all field values have been populated manually. Manually populated values must be specified at the entity-field level. This model does not necessarily imply that a user is populating the value in the UI for each entity; on the contrary, values are often populated via automated integrations or uploads; however, there must be a value specified for the field for each entity, or else the value will not be populated at all.

In some embodiments, computed values are distinct from manually populated values in that the logic to populate the value is defined at the field, or field-type level. The values are then populated according to this logic automatically for each entity.

### Selecting a Computation Method

When configuring that a field's value should be computed, in some embodiments the user will need to select the method by which the value will be computed. This method may be referred to as the computation method. A list of built-in computations may be maintained in some embodiments, including but not limited to AI-based computations. Some embodiments also support invoking a function, in order to ensure that developers can achieve any computation behavior through custom code.

For non-computed values, the computation method may simply be set to None; this may be the default for all fields. By choosing a computation method, the user is setting the field to have its value computed.

Synchronous vs. Asynchronous Computations

Some computations inevitably take time to execute. Typically, when calculations take time, some embodiments make them asynchronous, so that they do not block a related operation, or prevent the user from taking other actions. Some embodiments support a mechanism to allow computations to process asynchronously.

Allowing a computation to be asynchronous may impact interfaces where users are updating dependent fields. This consideration could include all interfaces for updating entities (UI, API, Upload, Connectors, CaC). With embedded fields, if a user updates a field in such a way that a dependent field embedding that field is made invalid, the update is rejected. However, if a computation was asynchronous, it would not be able to support this instantaneous validation; instead, some embodiments allow the initial update to succeed, and simply handle the implications of the computation subsequently, upon completion.

As an example, consider a “Generate a Description with AI” computation for the Description field having a recomputation dependency on the Name field, and this computation being asynchronous. The user flow in some embodiments would be something like:
1. User updates Name field via API;
2. API response does not contain updated description;
3. System kicks off job to recompute Description value with new name;
4. Wait;
5. Once completed, the Description field has the new value returned by the computation.

In some embodiments, each computation is declared as either asynchronous or synchronous. Developers may also be able to declare this for a Function. In some embodiments, users configuring fields may determine if they want a computation to run as asynchronous or synchronous.

### Field-Type-Level Model

In some embodiments, Computed Field Values logic may be defined at the field-type level, rather than at the field-level. To users, this distinction does not need to be exposed or understood; users may still be allowed to define Computed Value logic in-line for a particular field (be it a built-in or custom field). In practice, however, defining computation logic in-line when managing a specific field may create a new field type. This behavior is actually how defining validation for a field works traditionally, though to a user, this complexity is obfuscated, and they remain under the impression that the field type for the field is whichever base type they have selected, rather than a new type which is a combination of the base type and additional configuration.

A motivation to architect computed fields at the field-type-level is that doing so:
Ensures that computations can be defined for individual subfields of structs;
Allows users to share computation logic across multiple fields, if they wish to do so, since they can create a custom field type which includes computation logic; and
Align the design with a model, such that anything data-related is defined at the field-type-level, including validation.

There are no drawbacks to having computed fields live at the field-type-level as opposed to the field-level, since users will still be able to define computation logic when managing an individual field.

Read-Only vs. Overwritable

For a field where the value is computed, some embodiments support setting that value as read-only or overwritable. As the names imply, the distinction here is whether a user can manually modify the field's value, or whether the value is strictly computed.

Read-only may be used for deterministic, predictable computations, and/or those where the source of truth is not a human user. Examples of built-in fields which may be read-only include, but are not limited to, Created Timestamp, Last Updated Timestamp, and Entity UID.

In some embodiments, Overwritable will be a commonly-used pattern; customers can easily get most of the power of read-only fields by leveraging field-level permissions, while still maintaining the flexibility to edit a field's value when necessary.

### Post-Overwrite Behavior

For fields where the user has overwritten (modified) the computed value, some embodiments treat that value as now “detached” from the computation, so that it will not be recomputed.

In other embodiments, a user may review a generated value, edit it slightly (for example, to correct grammar), but still have the value recomputed if a dependent field is updated.

In some embodiments, the user may select whether or not edits should prevent future computations for that particular (profile, field) combination.

### A Different Model

Some embodiments provide a model where each field may have a user-provided value AND a computed value, and the decision would simply be which to select as the field's value:

Fields without computation methods would, by definition, always use the user-provided value;

Read-only fields would, by definition, always use the computed value; and

Non-read-only fields with computation methods would allow the user to select, per profile, which value to use.

Some advantages of this approach include the following examples:

A user who had previously overwritten a computed value may easily switch back to the computed value.

The system may continue to recompute new versions of the value, even when the value is not being sent as a Suggestion, without directly overwriting the user-provided value (aka overwrite).

### Read-Only+Suggestions

Read-Only implies that the value can only ever be updated by the Computed Values system; however, Suggestions is another system which makes updates to entities. In some embodiments, Read-Only values should never be able to flow through Suggestions, since a human reviewing the update could be seen as contrary to the concept of Read-Only values.

However, some embodiments do provide for read-only values to flow through Suggestions, while making the value un-editable—the user's only option would be to approve or reject the edit.

### Suggestions+Computed Values

In some embodiments, Suggestions are the KG primitive for reviewing non-authoritative content. The ability to leverage Suggestions directly as a part of Computed Values is an example of how the KG primitives fit together to provide a differentiated experience around computing and generating content, enriching the customer's KG.

In order to integrate Computed Values into Suggestions, some embodiments provide the Computed Value configuration to allow the user to select whether the value should be applied directly, or should be propagated as a Suggestion. On the Suggestions side, this includes:
A new suggestion source, which attributes the value to the computation;
The ability to regenerate a value from suggestions (see One-Off Computations); and
Special behavior around Read-Only computed values (see Read-Only+Suggestions).

### Computation Methods

In some embodiments, the user may select a computation method from the provided list of built-in computations, or by selecting a Function.

### Output Format

Both built-in and custom (function) Computation Methods may declare their output format in some embodiments; this format can be any Field Type, either built-in or custom. The declared output format may be used to limit the Computation Methods surfaced to the user based on their selected field type, as it is important that the data returned by the computation is structured to be populated in the field being configured.

### Inputs

In some embodiments, each Computation Method may declare a set of inputs, which are essentially the parameters which the computation will receive when computing the value for a given profile. Inputs may be surfaced to the user when configuring the field's Computation Method.

The properties of an input are described in Table 12.

TABLE 12
Input Properties

| Property | Type | Details |
|---|---|---|
| Name | String | The name of the input. This |
| | | name will be displayed to the |
| | | user in the UI. |
| Description | String | The description of the input, |
| | | to be rendered as a tooltip in |
| | | the UI. |
| Allowed Input Types | Enum | The allowed input types. |
| | | Specifically, can the input be |
| | | a text string, a field value, or |
| | | both. |
| | | One of: |
| | | Field |
| | | Text Input |
| | | For Field inputs, the accepted |
| | | input can be limited by type. |
| | | For example, for the |
| | | “Calculate Geocodes” |
| | | computation, the “Address” |
| | | input would require that the |
| | | user select a field of type |
| | | Address. |
| Required | Boolean | Whether or not the input is |
| | | required to be specified on- |
| | | configuration. |

Built-in Computation Example—Write a Blog Post with AI Computation

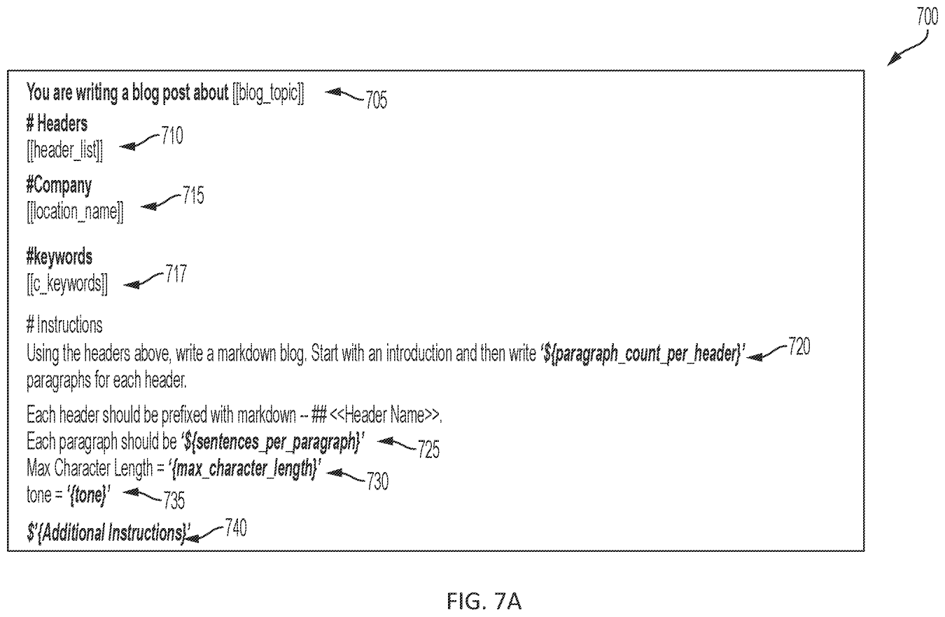

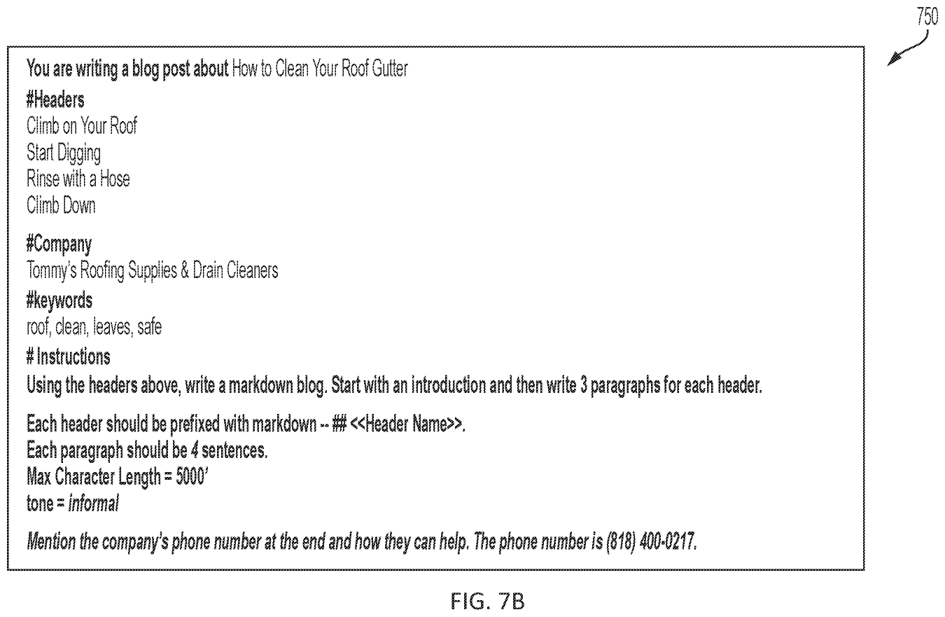

FIGS. 7A and 7B show an example of writing a blog post with AI computation. FIG. 7A shows an example of a prompt 700 for an AI content generation tool (e.g., a large language model). The inputs to the prompt 700 include a blog topic 705, a header list 710, a location name 715, keywords 717, a paragraph count 720 (per header), a sentence count 725 (per paragraph), a max character length 730, a tone 735, and additional instructions 740. Properties of these example prompt inputs are described further in Table 13.

TABLE 13
Prompt Input Properties

| Input Name | Description | Type | Required? | Example Value |
|---|---|---|---|---|
| Blog Topic | The topic of | Field | Yes | c_title |
| | the blog post. | (Single- | | |
| | | Line Text) | | |
| Header List | The list of | Field (Text | Yes | c_headers |
| | paragraph | List) | | |
| | headers you | | | |
| | want to | | | |
| | include. | | | |
| Location | The name of | Field | No | c_relatedLocation.name |
| Name | the location | (Single- | | |
| | providing the | Line Text) | | |
| | services | | | |
| | associated | | | |
| | with the blog | | | |
| | post. Will | | | |
| | enrich the | | | |
| | quality of the | | | |
| | post and | | | |
| | make it more | | | |
| | location- | | | |
| | centric. | | | |
| Keywords | Words or | Field | No | c_keywords |
| | phrases | (Single- | | |
| | relevant to | Line Text) | | |
| | the blog topic | | | |
| Paragraph | The number | Text Input | Yes | “3” |
| Count per | of paragraphs | (Number) | (Defaults to | |
| Header | for each | | 1) | |
| | header. | | | |
| Sentences | The number | Text Input | Yes | “6” |
| per | of sentences | (Number) | (Defaults to | |
| Paragraph | included in | | 5) | |
| | each | | | |
| | paragraph. | | | |
| Max | The | Text Input | Yes | “10,000” |
| Character | maximum | (Number) | (Defaults to | |
| Length | character | | 5000) | |
| | length for the | | | |
| | blog. | | | |
| Tone | The tone of | Text Input | Yes | c_postTone |
| | the blog post. | or Field | | OR |
| | For example, | | | “informal” |
| | “informal”. | | | |
| Additional | Any | Text Input | No | Mention the company's phone |
| Instructions | additional | (Multi- | | number at the end and how they |
| | instructions | Line) | | can help. The phone number is |
| | you want to | Can include | | [[c_relatedLocation.mainPhone]] |
| | include, to | embeds | | |
| | ensure any | | | |
| | behavior not | | | |
| | covered in | | | |
| | the other | | | |
| | inputs is | | | |
| | passed to the | | | |
| | model. | | | |

FIG. 7B shows an example of a prompt 750 to the model for a particular entity, using the example values in Table 13.

### Custom Computation Methods (via Functions)

### Output Format

Generally, Functions have no dedicated way to declare their output signature. Since Functions may be written in Typescript, a developer could set their return type explicitly, but this type would be a typescript type or interface, not a KG field type. Some embodiments support declaring an output format for Function Computation Methods.

### Inputs (aka Runtime Variables)

Since there is full control over the built-in computations, the model for Inputs can be defined. However, for Function computations, there may not be any mechanism for a Function to declare the inputs it expects.

Some embodiments provide Function “Runtime Variables”, which allow a function developer to define the set of inputs it expects for a function. With this model, a UI dynamically renders the Function “Runtime Variables” to the user for configuration, allowing the user to easily provide the relevant inputs.

### When is a Value Computed?

There are a number of points at which a field's value may be computed (or recomputed).

### On-Configuration (Backfill)

After saving a modified configuration, in some embodiments the user may be presented with the option to recompute the value across existing profiles. When desired, the system may run a task to compute the values and apply them (e.g., through Entity Jobs) to all relevant profiles for the relevant field.

### Field Dependencies

The concept of inputs was discussed in the dedicated section above; by leveraging inputs, a field's value on a given profile can be used dynamically to compute the value for that profile.

Clarification: In some embodiments, Inputs may be defined by the developer of the Computation Method. The user then selects the values to be used for those inputs-those selections can be fields. For each field used as an input, the user may want granular control over how that “dependency” field's value (or lack thereof) affects the computation of the value of the field being configured.

For any field being used in a computation, there are at least two types of “dependencies” to consider:

Required for Computation: If the input which the field is being used for is required, this may be true. If the input is optional, the user can set this to true.

For embodiments having computations which are highly dependent on a small number of fields, it's likely that most/all field inputs will have both dependencies selected. However, for embodiments having computations with a number of inputs, and those which may cost the customer money per computation (see GPT-based computations), it may be preferable to be able to more granularly control the behavior with respect to each Input Field.

Some embodiments expose a list of field inputs to the user, e.g., in a more advanced section of the configuration flow, and allow the user to denote the dependencies for each field input.

### Regeneration Cadence

Some embodiments support regenerating a value on a cadence. This behavior may be useful for scenarios in which the value's source is entirely external, so there is no field dependency to trigger recomputation, and/or the data is subject to change in the source data set.

In some embodiments, the regeneration cadence respects the last time the value was computed. For example, if a regeneration cadence of 30 days is set, but the field dependencies resulted in a recomputation 5 days ago, one would not expect the recomputation to occur simply because it had been 30 days since the last time the cadence triggered a regeneration; put another way, the schedule may reset each time the value is recomputed.

### One-Off (Entity Edit, Suggestions)

For fields with computed values, some embodiments support one-off recomputations, which the user may trigger for a given profile field, for example, in Entity Edit or Suggestions. This one-off computation may be valuable for computations that are non-deterministic, as the value can change each time the computation is executed.

Some embodiments support the “sandwich” workflow. This is a three-step process. First, a human has a creative impulse, and gives the AI a prompt. The AI then generates a menu of options. The human then chooses an option, edits it, and adds any touches they like.

Though in some embodiments, only single “option” may be generated up-front, the user may have a mechanism to generate more outputs and select the one they prefer.

### Multi-Language Behavior

Some embodiments handle computed values across multiple language profiles.

The localization behavior supported in some embodiments is summarized in Table 14.

TABLE 13
Prompt Input Properties

| Localization Type | Behavior |
|---|---|
| Primary Only | Values can only be set on the primary |
| | language profile. The value on the primary |
| | profile is inherited across any alternate |
| | language profiles for that field. |
| Overridable | Values can be set on the primary language |
| | profile OR any alternate language profiles. |
| | If the field's value is unset on a given |
| | alternate language profile, the value from the |
| | primary profile is inherited on that profile. |
| Locale Specific | Values will be unset unless they are explicitly |
| | provided on a given profile. There is no |
| | inheritance from values set on the primary |
| | profile to the alternate language profiles. |

Some computations, especially those centered around content generation, may be inherently language-specific. For example, for an input prompt for a LLM in English, the generated content is going to be in English.

Additionally, in some embodiments, fields are made available to Entity Types. A set of entities of the same type may have a “mixed” set of primary profile languages. In other words, multiple entities of the same type have different locales set as their primary profile. This behavior means that if a computation was only defined for the primary profile, any language-specific computations would still not necessarily execute as desired, since the language of the primary profiles could be varied.

### Language Specific Computations

As mentioned above, certain values may be language specific. Whether or not the value can be language specific may be determined in some embodiments when selecting the field's localization behavior:

Primary-Only implies the value is agnostic to the language; and

Overridable/Locale Specific implies the value can/must (respectively) be localized in order to be coherent.

For content which can or must be localized in order to be coherent, computation must take localization into account.

### Function Computations

A function can take the profile locale as a parameter, and handle it as it wishes.

### Built-in Computations

Different embodiments may provide different options to support localized computations.

Option 1—Compute in a Single Language & Translate Result

Some embodiments allow the user to specify the computation in a single language, and support translation as a first-class feature. One could use a translation API, a LLM, or a combination of the two.

### Option 1.5—Translate the Prompt

Rather than computing in a single language and translating the result, some embodiments translate the prompt, and pass that to the large language model.

### Option 2—Compute in Each Language

Some embodiments have a dedicated computation in each language. For the LLM-based computations, this may mean a pre-written prompt in each language.

If this option is selected, there is also the question of whether the user must translate their text inputs up-front, or whether the system can handle that on their behalf.

Consider the example of Writing a Blog Post with AI described above with reference to FIGS. 7A and 7B, where the user provides the string “Mention the company's phone number at the end and how they can help. The phone number is [c_relatedLocation.mainPhone]” or that the tone is “informal” in each language they want the computation to work in.

### Translation as a Computation

Some embodiments provide translation as a dedicated computation, where the computed value would only be the content translated from the primary profile.

### Logging & Debugging

Some embodiments provide an interface for the user to see how a particular value was computed; specifically, the inputs from the profile that went into the computation.

### Supported Computations

The list of computations may be a combination of:

Programmatic Computations;

LLM-based generative computations (e.g., ChatGPT); and

Invoking a function.

The system may include a number of components that each may be implemented on a server or on an end-user device. In some cases, a subset of the components may execute on a user device (e.g., a mobile application on a cell phone, a webpage running within a web browser, a local application executing on a personal computer, etc.) and another subset of the components may execute on a server (a physical machine, virtual machine, or container, etc., which may be located at a datacenter, a cloud computing provider, a local area network, etc.).

The components of the system may be implemented in some embodiments as software programs or modules, which are described in more detail below. In other embodiments, some or all of the components may be implemented in hardware, including in one or more signal processing and/or application specific integrated circuits. While the components are shown as separate components, two or more components may be integrated into a single component. Also, while many of the components' functions are described as being performed by one component, the functions may be split among two or more separate components.

In addition, at least one figure conceptually illustrates a process. The specific operations of this process may not be performed in the exact order shown and described. The specific operations may not be performed in one continuous series of operations, and different specific operations may be performed in different embodiments. Furthermore, the process could be implemented using several sub-processes, or as part of a larger macro process.

The terms “computer”, “server”, “processor”, and “memory” all refer to electronic or other technological devices. These terms exclude people or groups of people. As used in this specification, the terms “computer readable medium,” “computer readable media,” and “machine readable medium,” etc. are entirely restricted to tangible, physical objects that store information in a form that is readable by a computer. These terms exclude any wireless signals, wired download signals, and any other ephemeral signals.

The term “computer” is intended to have a broad meaning that may be used in computing devices such as, e.g., but not limited to, standalone or client or server devices. The computer may be, e.g., (but not limited to) a personal computer (PC) system running an operating system such as, e.g., (but not limited to) MICROSOFT® WINDOWS® available from MICROSOFT® Corporation of Redmond, Wash., U.S.A. or an Apple computer executing MAC® OS from Apple® of Cupertino, Calif., U.S.A. However, the invention is not limited to these platforms. Instead, the invention may be implemented on any appropriate computer system running any appropriate operating system. In one illustrative embodiment, the present invention may be implemented on a computer system operating as discussed herein. The computer system may include, e.g., but is not limited to, a main memory, random access memory (RAM), and a secondary memory, etc. Main memory, random access memory (RAM), and a secondary memory, etc., may be a computer-readable medium that may be configured to store instructions configured to implement one or more embodiments and may comprise a random-access memory (RAM) that may include RAM devices, such as Dynamic RAM (DRAM) devices, flash memory devices, Static RAM (SRAM) devices, etc.

The secondary memory may include, for example, (but not limited to) a hard disk drive and/or a removable storage drive, representing a floppy diskette drive, a magnetic tape drive, an optical disk drive, a read-only compact disk (CD-ROM), digital versatile discs (DVDs), flash memory (e.g., SD cards, mini-SD cards, micro-SD cards, etc.), read-only and recordable Blu-Ray® discs, etc. The removable storage drive may, e.g., but is not limited to, read from and/or write to a removable storage unit in a well-known manner. The removable storage unit, also called a program storage device or a computer program product, may represent, e.g., but is not limited to, a floppy disk, magnetic tape, optical disk, compact disk, etc. which may be read from and written to the removable storage drive. As will be appreciated, the removable storage unit may include a computer usable storage medium having stored therein computer software and/or data.

In some embodiments, the secondary memory may include other similar devices for allowing computer programs or other instructions to be loaded into the computer system. Such devices may include, for example, a removable storage unit and an interface. Examples of such may include a program cartridge and cartridge interface (such as, e.g., but not limited to, those found in video game devices), a removable memory chip (such as, e.g., but not limited to, an erasable programmable read only memory (EPROM), or programmable read only memory (PROM) and associated socket, and other removable storage units and interfaces, which may allow software and data to be transferred from the removable storage unit to the computer system.

Some embodiments include electronic components, such as microprocessors, storage and memory that store computer program instructions in a machine-readable or computer-readable medium (alternatively referred to as computer-readable storage media, machine-readable media, or machine-readable storage media). The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

The computer may also include an input device may include any mechanism or combination of mechanisms that may permit information to be input into the computer system from, e.g., a user. The input device may include logic configured to receive information for the computer system from, e.g., a user. Examples of the input device may include, e.g., but not limited to, a mouse, pen-based pointing device, or other pointing device such as a digitizer, a touch sensitive display device, and/or a keyboard or other data entry device (none of which are labeled). Other input devices may include, e.g., but not limited to, a biometric input device, a video source, an audio source, a microphone, a web cam, a video camera, and/or another camera. The input device may communicate with a processor either wired or wirelessly.

The computer may also include output devices which may include any mechanism or combination of mechanisms that may output information from a computer system. An output device may include logic configured to output information from the computer system. Embodiments of output device may include, e.g., but not limited to, display, and display interface, including displays, printers, speakers, cathode ray tubes (CRTs), plasma displays, light-emitting diode (LED) displays, liquid crystal displays (LCDs), printers, vacuum florescent displays (VFDs), surface-conduction electron-emitter displays (SEDs), field emission displays (FEDs), etc. The computer may include input/output (I/O) devices such as, e.g., (but not limited to) communications interface, cable and communications path, etc. These devices may include, e.g., but are not limited to, a network interface card, and/or modems. The output device may communicate with processor either wired or wirelessly. A communications interface may allow software and data to be transferred between the computer system and external devices.

The terms “processor,” “processing unit,” “data processor,” etc. are intended to have a broad meaning that includes one or more processors, such as, e.g., but not limited to, processors that are connected to a communication infrastructure (e.g., but not limited to, a communications bus, cross-over bar, interconnect, or network, etc.). The terms may include any type of processor, microprocessor and/or processing logic that may interpret and execute instructions, including application-specific integrated circuits (ASICs) and field-programmable gate arrays (FPGAs). The data processor may comprise a single device (e.g., for example, a single core) and/or a group of devices (e.g., multi-core). The data processor may include logic configured to execute computer-executable instructions configured to implement one or more embodiments. The instructions may reside in main memory or secondary memory. The data processor may also include multiple independent cores, such as a dual-core processor or a multi-core processor. The data processors may also include one or more graphics processing units (GPU) which may be in the form of a dedicated graphics card, an integrated graphics solution, and/or a hybrid graphics solution. Various illustrative software embodiments may be described in terms of this illustrative computer system. After reading this description, it will become apparent to a person skilled in the relevant art(s) how to implement the invention using other computer systems and/or architectures.

The term “data storage device” is intended to have a broad meaning that includes removable storage drive, a hard disk installed in hard disk drive, flash memories, removable discs, non-removable discs, etc. In addition, it should be noted that various electromagnetic radiation, such as wireless communication, electrical communication carried over an electrically conductive wire (e.g., but not limited to twisted pair, CAT5, etc.) or an optical medium (e.g., but not limited to, optical fiber) and the like may be encoded to carry computer-executable instructions and/or computer data that embodiments of the invention on e.g., a communication network. These computer program products may provide software to the computer system. It should be noted that a computer-readable medium that comprises computer-executable instructions for execution in a processor may be configured to store various embodiments of the present invention.

The term “network” is intended to include any communication network, including a local area network (“LAN”), a wide area network (“WAN”), an Intranet, or a network of networks, such as the Internet.

The term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure. For example, unless otherwise explicitly indicated, the steps of a process or method may be performed in an order other than the example embodiments discussed above. Likewise, unless otherwise indicated, various components may be omitted, substituted, or arranged in a configuration other than the example embodiments discussed above.

It is to be understood that the present disclosure contemplates that, to the extent possible, one or more features of any embodiment can be combined with one or more features of any other embodiment.

Further aspects of the present disclosure are provided by the subject matter of the following numbered clauses.

1. A method for a computer system, comprising: generating a knowledge graph comprising a plurality of nodes, each node comprising at least one field to store data, and being associated with at least one other node; at a particular node, defining a plurality of fields, wherein a first field in the plurality of fields has a dependence on a second field in the plurality of fields; receiving data at the knowledge graph; using the received data, defining a value of the second field; using the value of the second field, generating a computed value for the first field, based on the dependence; and updating the first field using the computed value.

2. The method of clause 1, wherein generating the computed value for the first field comprises performing an operation, wherein the value of the second field is an input to the operation, and the computed value for the first field is an output of the operation.

3. The method of any of clauses 1-2, wherein the operation comprises a transform, and performing the operation comprises applying the transform to the value of the second field.

4. The method of any of clauses 1-2, wherein the operation is defined by a user.

5. The method of any of clauses 1-2, wherein the operation is one of a plurality of pre-defined operations, and the method further comprises receiving, at the particular node in the knowledge graph, a selection of the operation from the plurality of pre-defined operations.

6. The method of any of clauses 1-2, wherein the operation comprises: generating a request to an external data source, the request comprising the value of the second field; providing the request to the external data source; receiving a response from the external data source; and generating the computed value for the first field using the response from the external data source.

7. The method of any of clauses 1-6, wherein the external data source is a machine learning model, the request is a prompt to the machine learning model, and the response is an output of the machine learning model to the prompt.

8. The method of any of clauses 1-6, wherein the external data source is a database, the request is a query to the database, and the response is a reply of the database to the query.

9. The method of any of clauses 1-6, wherein the external data source is an application programming interface (API), the request is an input to the API, and the response is an output of the API to the input.

10. The method of any of clauses 1-9, wherein the received data is received from a user.

11. The method of any of clauses 1-10, further comprising: receiving an indication at the particular node in the knowledge graph; and updating the first field in response to receiving the indication.

12. The method of any of clauses 1-11, wherein the indication is received by a user.

13. The method of any of clauses 1-11, wherein the indication is triggered by a change in a value of at least one field in the plurality of fields.

14. The method of any of clauses 1-11, wherein the indication is automatically triggered after a period of time.

15. The method of any of clauses 1-11, wherein the node is a first node that is associated with a second node in the knowledge graph, the method further comprising updating a field of the second node based on the computed value.

16. The method of any of clauses 1-15, further comprising: providing the computed value for the first field as an input to a plurality of operations; and performing the plurality of operations to generate a plurality of outputs.

17. The method of any of clauses 1-16, wherein defining the value of the second field comprises: applying a data model to transform the received data; and defining the value of at least the second field based on the transformed data, wherein the data model provides a mapping from the received data to the plurality of fields of the particular node.

18. The method of any of clauses 1-17, wherein the received data comprises a profile, and defining the value of the second field comprises applying the profile to the second field.

19. The method of any of clauses 1-18, wherein updating the first field using the computed value comprises performing a validation on the computed value, wherein the validation comprises at least one rule to which any value of the first field must conform.

20. The method of any of clauses 1-19, further comprising providing the computed value to a user as a suggested value, and receiving a confirmation from the user to proceed to update the first field using the suggested value.

21. A system comprising: at least one processor; and a non-transitory computer-readable storage medium storing instructions which, when executed by the at least one processor, cause the at least one processor to: generate a knowledge graph comprising a plurality of nodes, each node comprising at least one field to store data, and being associated with at least one other node; at a particular node, define a plurality of fields, wherein a first field in the plurality of fields has a dependence on a second field in the plurality of fields; receive data at the knowledge graph; using the received data, define a value of the second field; using the value of the second field, generate a computed value for the first field, based on the dependence; and update the first field using the computed value.

22. The system of clause 21, wherein generating the computed value for the first field comprises performing an operation, wherein the value of the second field is an input to the operation, and the computed value for the first field is an output of the operation.

23. The system of any of clauses 21-22, wherein the operation comprises a transform, and performing the operation comprises applying the transform to the value of the second field.

24. The system of any of clauses 21-22, wherein the operation is defined by a user.

25. The system of any of clauses 21-22, wherein the operation is one of a plurality of pre-defined operations, and executing the instructions further cause the at least one processor to receive, at the particular node in the knowledge graph, a selection of the operation from the plurality of pre-defined operations.

26. The system of any of clauses 21-22, wherein the operation comprises: generating a request to an external data source, the request comprising the value of the second field; providing the request to the external data source; receiving a response from the external data source; and generating the computed value for the first field using the response from the external data source.

27. The system of any of clauses 21-26, wherein the external data source is a machine learning model, the request is a prompt to the machine learning model, and the response is an output of the machine learning model to the prompt.

28. The system of any of clauses 21-26, wherein the external data source is a database, the request is a query to the database, and the response is a reply of the database to the query.

29. The system of any of clauses 21-26, wherein the external data source is an application programming interface (API), the request is an input to the API, and the response is an output of the API to the input.

30. The system of any of clauses 21-29, wherein the received data is received from a user.

31. The system of any of clauses 21-30, wherein executing the instructions further cause the at least one processor to: receive an indication at the particular node in the knowledge graph; and update the first field in response to receiving the indication.

32. The system of any of clauses 21-31, wherein the indication is received by a user.

33. The system of any of clauses 21-31, wherein the indication is triggered by a change in a value of at least one field in the plurality of fields.

34. The system of any of clauses 21-31, wherein the indication is automatically triggered after a period of time.

35. The system of any of clauses 21-31, wherein the node is a first node that is associated with a second node in the knowledge graph, and executing the instructions further cause the at least one processor to update a field of the second node based on the computed value.

36. The system of any of clauses 21-35, wherein executing the instructions further cause the at least one processor to: provide the computed value for the first field as an input to a plurality of operations; and perform the plurality of operations to generate a plurality of outputs.

37. The system of any of clauses 21-36, wherein defining the value of the second field comprises: applying a data model to transform the received data; and defining the value of at least the second field based on the transformed data, wherein the data model provides a mapping from the received data to the plurality of fields of the particular node.

38. The system of any of clauses 21-37, wherein the received data comprises a profile, and defining the value of the second field comprises applying the profile to the second field.

39. The system of any of clauses 21-38, wherein updating the first field using the computed value comprises performing a validation on the computed value, wherein the validation comprises at least one rule to which any value of the first field must conform.

40. The system of any of clauses 21-39, wherein executing the instructions further cause the at least one processor to provide the computed value to a user as a suggested value, and receive a confirmation from the user to proceed to update the first field using the suggested value.

41. A non-transitory computer-readable storage medium storing instructions which, when executed by a computing device, cause the computing device to: generate a knowledge graph comprising a plurality of nodes, each node comprising at least one field to store data, and being associated with at least one other node; at a particular node, define a plurality of fields, wherein a first field in the plurality of fields has a dependence on a second field in the plurality of fields; receive data at the knowledge graph; using the received data, define a value of the second field; using the value of the second field, generate a computed value for the first field, based on the dependence; and update the first field using the computed value.

42. The non-transitory computer-readable storage medium of clause 41, wherein generating the computed value for the first field comprises performing an operation, wherein the value of the second field is an input to the operation, and the computed value for the first field is an output of the operation.

43. The non-transitory computer-readable storage medium of any of clauses 41-42, wherein the operation comprises a transform, and performing the operation comprises applying the transform to the value of the second field.

44. The non-transitory computer-readable storage medium of any of clauses 41-42, wherein the operation is defined by a user.

45. The non-transitory computer-readable storage medium of any of clauses 41-42, wherein the operation is one of a plurality of pre-defined operations, and executing the instructions further cause the computing device to receive, at the particular node in the knowledge graph, a selection of the operation from the plurality of pre-defined operations.

46. The non-transitory computer-readable storage medium of any of clauses 41-42, wherein the operation comprises: generating a request to an external data source, the request comprising the value of the second field; providing the request to the external data source; receiving a response from the external data source; and generating the computed value for the first field using the response from the external data source.

47. The non-transitory computer-readable storage medium of any of clauses 41-46, wherein the external data source is a machine learning model, the request is a prompt to the machine learning model, and the response is an output of the machine learning model to the prompt.

48. The non-transitory computer-readable storage medium of any of clauses 41-46, wherein the external data source is a database, the request is a query to the database, and the response is a reply of the database to the query.

49. The non-transitory computer-readable storage medium of any of clauses 41-46,

wherein the external data source is an application programming interface (API), the request is an input to the API, and the response is an output of the API to the input.

50. The non-transitory computer-readable storage medium of any of clauses 41-49, wherein the received data is received from a user.

51. The non-transitory computer-readable storage medium of any of clauses 41-50,

wherein executing the instructions further cause the computing device to: receive an indication at the particular node in the knowledge graph; and update the first field in response to receiving the indication.

52. The non-transitory computer-readable storage medium of any of clauses 41-51, wherein the indication is received by a user.

53. The non-transitory computer-readable storage medium of any of clauses 41-51, wherein the indication is triggered by a change in a value of at least one field in the plurality of fields.

54. The non-transitory computer-readable storage medium of any of clauses 41-51, wherein the indication is automatically triggered after a period of time.

55. The non-transitory computer-readable storage medium of any of clauses 41-51, wherein the node is a first node that is associated with a second node in the knowledge graph, and executing the instructions further cause the computing device to update a field of the second node based on the computed value.

56. The non-transitory computer-readable storage medium of any of clauses 41-55, wherein executing the instructions further cause the computing device to: provide the computed value for the first field as an input to a plurality of operations; and perform the plurality of operations to generate a plurality of outputs.

57. The non-transitory computer-readable storage medium of any of clauses 41-56, wherein defining the value of the second field comprises: applying a data model to transform the received data; and defining the value of at least the second field based on the transformed data, wherein the data model provides a mapping from the received data to the plurality of fields of the particular node.

58. The non-transitory computer-readable storage medium of any of clauses 41-57, wherein the received data comprises a profile, and defining the value of the second field comprises applying the profile to the second field.

59. The non-transitory computer-readable storage medium of any of clauses 41-58, wherein updating the first field using the computed value comprises performing a validation on the computed value, wherein the validation comprises at least one rule to which any value of the first field must conform.

60. The non-transitory computer-readable storage medium of any of clauses 41-59, wherein executing the instructions further cause the computing device to provide the computed value to a user as a suggested value, and receive a confirmation from the user to proceed to update the first field using the suggested value.

We claim:

1. A system comprising:
at least one processor; and
a non-transitory computer-readable storage medium storing instructions which, when executed by the at least one processor, cause the at least one processor to:
generate a knowledge graph comprising a plurality of nodes, each node comprising at least one field to store data, and being associated with at least one other node;
at a particular node, define a plurality of fields, wherein a first field in the plurality of fields has a dependence on a second field in the plurality of fields;
receive data at the knowledge graph;
using the received data, define a value of the second field;
using the value of the second field, generate a computed value for the first field, based on the dependence; and
update the first field using the computed value.

2. The system of claim 1, wherein generating the computed value for the first field comprises performing an operation, wherein the value of the second field is an input to the operation, and the computed value for the first field is an output of the operation.

3. The system of claim 2, wherein the operation comprises a transform, and performing the operation comprises applying the transform to the value of the second field.

4. The system of claim 2, wherein the operation is defined by a user.

5. The system of claim 2, wherein the operation is one of a plurality of pre-defined operations, and executing the instructions further cause the at least one processor to receive, at the particular node in the knowledge graph, a selection of the operation from the plurality of pre-defined operations.

6. The system of claim 2, wherein the operation comprises:
generating a request to an external data source, the request comprising the value of the second field;
providing the request to the external data source;
receiving a response from the external data source; and
generating the computed value for the first field using the response from the external data source.

7. The system of claim 6, wherein the external data source is a machine learning model, the request is a prompt to the machine learning model, and the response is an output of the machine learning model to the prompt.

8. The system of claim 6, wherein the external data source is a database, the request is a query to the database, and the response is a reply of the database to the query.

9. The system of claim 6, wherein the external data source is an application programming interface (API), the request is an input to the API, and the response is an output of the API to the input.

10. The system of claim 1, wherein the received data is received from a user.

11. The system of claim 1, wherein executing the instructions further cause the at least one processor to:
receive an indication at the particular node in the knowledge graph; and
update the first field in response to receiving the indication.

12. The system of claim 11, wherein the indication is received by a user.

13. The system of claim 11, wherein the indication is triggered by a change in a value of at least one field in the plurality of fields.

14. The system of claim 11, wherein the indication is automatically triggered after a period of time.

15. The system of claim 11, wherein the node is a first node that is associated with a second node in the knowledge graph, and executing the instructions further cause the at least one processor to update a field of the second node based on the computed value.

16. The system of claim 1, wherein executing the instructions further cause the at least one processor to:
provide the computed value for the first field as an input to a plurality of operations; and
perform the plurality of operations to generate a plurality of outputs.

17. The system of claim 1, wherein defining the value of the second field comprises:
applying a data model to transform the received data; and
defining the value of at least the second field based on the transformed data,
wherein the data model provides a mapping from the received data to the plurality of fields of the particular node.

18. The system of claim 1, wherein the received data comprises a profile, and defining the value of the second field comprises applying the profile to the second field.

19. The system of claim 1, wherein updating the first field using the computed value comprises performing a validation on the computed value, wherein the validation comprises at least one rule to which any value of the first field must conform.

20. The system of claim 1, wherein executing the instructions further cause the at least one processor to provide the computed value to a user as a suggested value, and receive a confirmation from the user to proceed to update the first field using the suggested value.
